(19) United States
(12) Patent Application Publication
(10) Pub. No.: US 2026/0085960 A1
(43) Pub. Date: Mar. 26, 2026

(54) Capacitance Sensor

(71) Applicant: SEIKO EPSON CORPORATION, Tokyo (JP)

(72) Inventors: Tatsuya OTA, Minowa (JP); Hisahiro ITO, Minowa (JP); Akio TSUTSUMI, Chino (JP); Hideo HANEDA, Shiojiri (JP)

(21) Appl. No.: 19/338,394

(22) Filed: Sep. 24, 2025

(30) Foreign Application Priority Data
Sep. 25, 2024 (JP) 2024-166012

(51) Int. Cl. G01F 23/263

(52) U.S. Cl. CPC G01F 23/266

(57) ABSTRACT

A capacitance sensor includes a package, an oscillation circuit, a switch circuit, a first reference capacitor, and a first electrode and a second electrode. The oscillation circuit includes an amplifier and a resonator connected between an input node and an output node of the amplifier. The first electrode is an electrode for sensing. The second electrode is an electrode having a fixed potential. The switch circuit switches between connecting the first electrode to and connecting one end of the first reference capacitor to a first node which is one of the input node and the output node of the amplifier. An oscillation frequency of the oscillation circuit changes according to a first capacitance between the first electrode and the second electrode when the first electrode is connected to the first node.

The present application is based on, and claims priority from JP Application Serial Number 2024-166012, filed Sep. 25, 2024, the disclosure of which is hereby incorporated by reference herein in its entirety.

### BACKGROUND

### 1. Technical Field

The present disclosure relates to a capacitance sensor.

### 2. Related Art

JP-A-2003-57095 describes a liquid level detector. The liquid level detector causes an oscillation circuit to oscillate using, as an oscillation time constant, capacitance and resistance which change as a liquid level to be measured changes, and outputs a digital signal corresponding to the change in the liquid level based on an output signal of the oscillation circuit.

However, according to the liquid level detector disclosed in JP-A-2003-57095, since the oscillation circuit oscillates due to charging and discharging of capacitance, an oscillation frequency of the oscillation circuit tends to fluctuate due to the influence of external amplitude noise, and since the oscillation frequency fluctuates due to a temperature and aging of the oscillation circuit, it is difficult to achieve high detection accuracy.

### SUMMARY

According to an aspect of the disclosure, there is provided a capacitance sensor including a package; an oscillation circuit provided inside the package; a switch circuit provided inside the package; a first reference capacitor provided inside the package; and a first electrode and a second electrode provided outside the package, the oscillation circuit includes an amplifier and a resonator provided inside the package and connected between an input node and an output node of the amplifier, the first electrode is an electrode for sensing, the second electrode is an electrode having a fixed potential, the switch circuit switches between connecting the first electrode to and connecting one end of the first reference capacitor to a first node which is one of the input node and the output node of the amplifier, and an oscillation frequency of the oscillation circuit changes according to a first capacitance between the first electrode and the second electrode when the first electrode is connected to the first node.

According to another aspect of the disclosure, there is provided a capacitance sensor including an oscillation circuit; a switch circuit; a first reference capacitor; and a first electrode and a second electrode, the oscillation circuit includes an amplifier and a resonator connected between an input node and an output node of the amplifier, the first electrode is an electrode for sensing, the second electrode is an electrode having a fixed potential, the switch circuit switches between connecting the first electrode to and connecting one end of the first reference capacitor to a first node which is one of the input node and the output node of the amplifier, a first capacitance between the first electrode and the second electrode changes according to a state of a detection target, and an oscillation frequency of the oscillation circuit changes according to the first capacitance when the first electrode is connected to the first node.

### BRIEF DESCRIPTION OF THE DRAWINGS

FIG. 1 is a view illustrating an appearance of a capacitance sensor according to a first embodiment.

FIG. 2 is a plan view illustrating an example of an internal structure of an oscillator.

FIG. 3 is a plan view illustrating another example of the internal structure of the oscillator.

FIG. 4 is a view illustrating an example of use of the capacitance sensor.

FIG. 5 is a functional block diagram of the capacitance sensor according to the first embodiment.

FIG. 6 is a diagram illustrating a configuration example of a drive circuit and a buffer circuit.

FIG. 7 is a diagram illustrating an equivalent circuit of a resonator.

FIG. 8 is a graph illustrating an example of a relationship between a load capacitance CL and a normalized frequency Δf/f₀.

FIG. 9 is a timing chart of various signals.

FIG. 10 is a timing chart when measurement is performed several times.

FIG. 11 is a graph illustrating a comparison of variable frequency characteristics with respect to a load capacitance C_{L} between an LC oscillation circuit and an oscillation circuit using a resonator.

FIG. 12 is a view illustrating the appearance of a capacitance sensor according to a second embodiment.

FIG. 13 is a functional block diagram of the capacitance sensor according to the second embodiment.

FIG. 14 is a diagram illustrating a configuration example of a drive circuit and a buffer circuit.

### DESCRIPTION OF EMBODIMENTS

Hereinafter, preferred embodiments of the present disclosure will be described in detail with reference to the drawings. It should be noted that the embodiments described below do not unduly limit the contents of the present disclosure described in the appended claims. In addition, all of the configurations described below are not necessarily essential components of the present disclosure.

### 1. First Embodiment

### 1-1. Structure of Capacitance Sensor

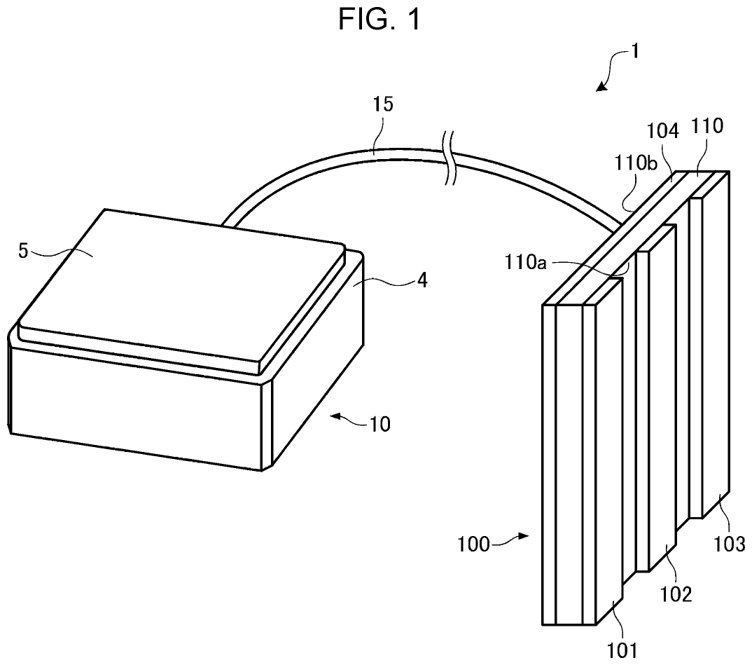

FIG. 1 is a view illustrating an appearance of a capacitance sensor 1 according to the first embodiment. As illustrated in FIG. 1, the capacitance sensor 1 of the first embodiment includes an oscillator 10, a sensing unit 100, and a cable 15 that connects the oscillator 10 and the sensing unit 100.

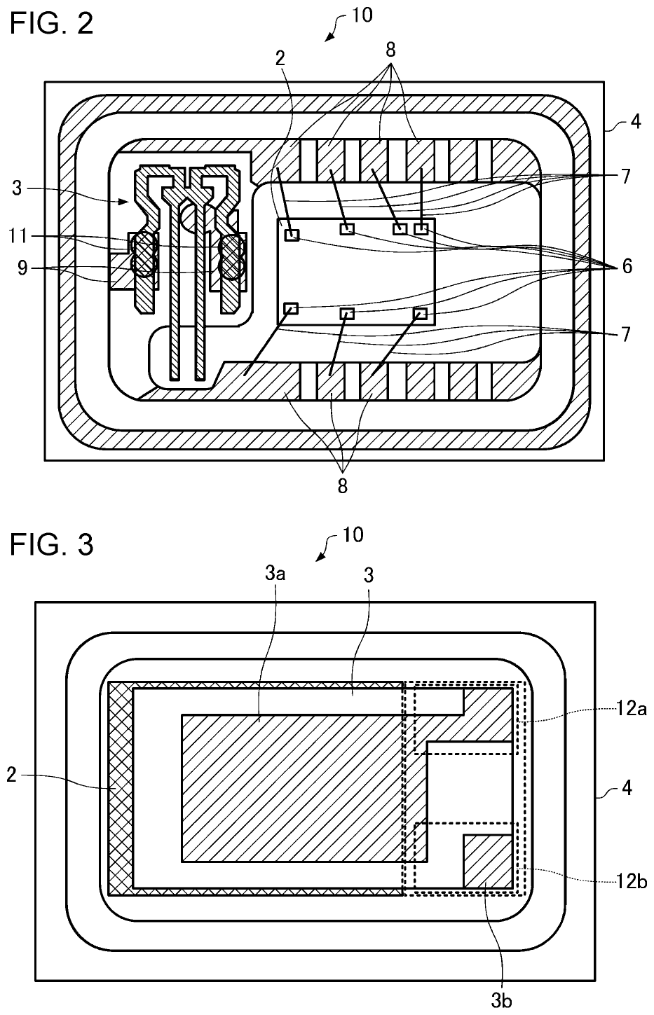

FIG. 2 is a plan view illustrating an example of the internal structure of the oscillator 10. As illustrated in FIGS. 1 and 2, the oscillator 10 includes a circuit device 2, a resonator 3, a package 4, and a lid 5. In FIG. 2, the lid 5 is not illustrated.

The oscillator 10 is, for example, an oscillator having a single seal structure, and the package 4 is a container that accommodates the circuit device 2 and the resonator 3 in the same space. That is, the circuit device 2 and the resonator 3 are provided inside the package 4. Specifically, a recessed portion is provided in the package 4, and the circuit device 2 and the resonator 3 are accommodated by covering the recessed portion with the lid 5. The oscillator 10 does not necessarily have a single seal structure, and for example, the package 4 may be a container in which the circuit device 2 and the resonator 3 are accommodated in separate spaces. Specifically, the package 4 may be provided with two recessed portions on an opposing surface, the resonator 3 may be accommodated by covering one recessed portion with the lid 5, and the circuit device 2 may be accommodated by covering the other recessed portion with a sealing member.

In the present embodiment, the circuit device 2 is implemented by a one chip integrated circuit. However, at least a part of the circuit device 2 may be configured by discrete components. In the example of FIG. 2, the circuit device 2 is mounted on the inner bottom surface of the package 4 via an adhesive or the like such that the surface on which a plurality of pads 6 are formed is the upper surface. Each of the plurality of pads 6 is connected to one of a plurality of electrodes 8 formed on the surface of the recessed portion of the package 4 by a bonding wire 7.

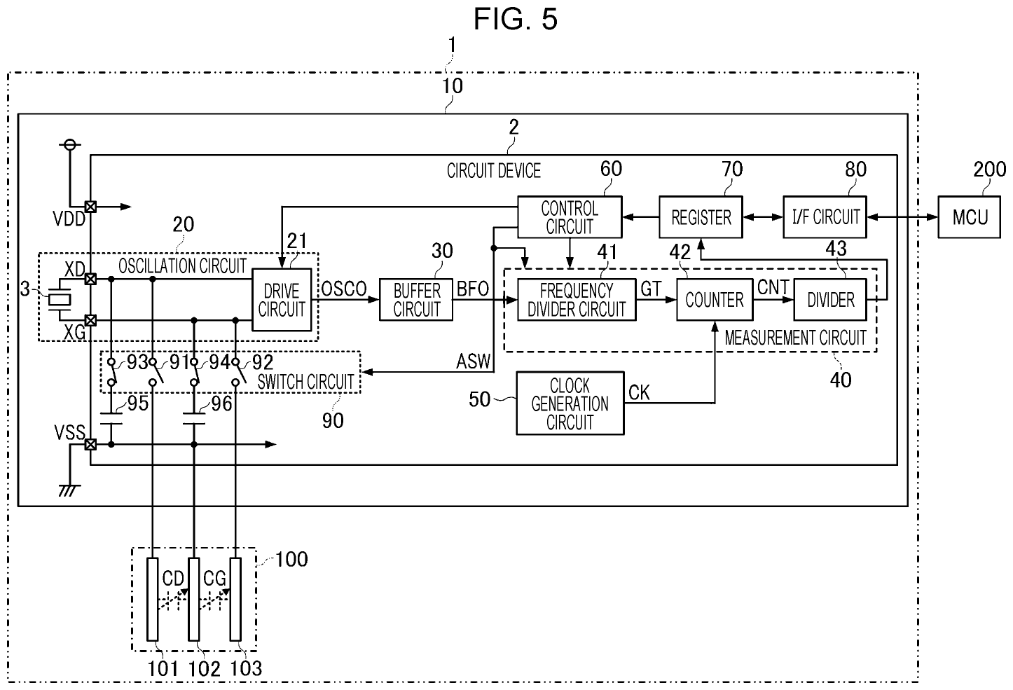

The resonator 3 is a piezoelectric resonator using a piezoelectric material such as a piezoelectric single crystal such as quartz crystal, lithium tantalate, or lithium niobate, or a piezoelectric ceramic such as lead zirconate titanate as a substrate material. Alternatively, the resonator 3 is a micro electro mechanical systems (MEMS) resonator which uses a silicon substrate or the like as a substrate material and is excited by electrostatic attractive force. For example, the resonator 3 is a quartz crystal resonator using quartz crystal as a substrate material, and is a tuning fork type quartz crystal resonator in the example of FIG. 2. Each of the two support arms of the resonator 3 is bonded, by a conductive bonding member 11, to each of two electrodes 9 formed on the surface of the recessed portion of the package 4. That is, the support arms of the resonator 3 are fixed to and electrically connected to the electrodes 9. Two electrodes 9 are electrically connected to the two electrodes 8 and the two pads 6 of the circuit device 2, specifically, an XD terminal and an XG terminal of FIG. 5 to be described later by wiring provided in the package 4.

An electrode pattern (not illustrated) is formed on each of the two support arms and the two vibrating arms of the resonator 3. Then, a signal generated in the one electrode pattern is supplied from one electrode 8 to the XG terminal of the circuit device 2, an amplifier included in the circuit device 2 amplifies the signal, and the amplified signal is supplied from the XD terminal to the resonator 3 via the other electrode 9, whereby the two vibrating arms of the resonator 3 continue to vibrate like a tuning fork. Thus, an oscillation circuit including the resonator 3 and the amplifier oscillates.

FIG. 3 is a plan view illustrating another example of the internal structure of the oscillator 10. In the example of FIG. 3, the circuit device 2 is mounted on the bottom surface of the recessed portion of the package 4, and the resonator 3 is mounted above the circuit device 2 with a gap provided therebetween.

In the example of FIG. 3, the resonator 3 is an AT cut quartz crystal resonator. The resonator 3 has the metal excitation electrodes 3a and 3b on the front surface and the rear surface respectively, and vibrates at a desired frequency according to the shape and the mass of the resonator 3 including the excitation electrodes 3a and 3b. The excitation electrodes 3a and 3b are respectively bonded to two electrodes 12a and 12b formed on the surfaces of the recessed portion of the package 4. The package 4 is provided with wiring (not illustrated) for electrically connecting two terminals of the circuit device 2, specifically, the XD terminal and the XG terminal in FIG. 5 to be described later, to the electrodes 12a and 12b, respectively. Then, a signal generated in one of the excitation electrodes 3a and 3b is supplied to the XG terminal of the circuit device 2, an amplifier included in the circuit device 2 amplifies the signal, and the amplified signal is supplied from the XD terminal to the resonator 3 via the other of the excitation electrodes 3a and 3b, whereby the thickness-shear vibration in which the front surface and the rear surface of the resonator 3 move in opposite directions to each other is continued. Thus, an oscillation circuit including the resonator 3 and the amplifier oscillates.

In the oscillator 10, a plurality of external connection terminals (not illustrated) are provided on the rear surface of the package 4 which is the bottom surface. In addition, the package 4 is provided with wiring (not illustrated) for electrically connecting each terminal of the circuit device 2 and each external connection terminal provided on the bottom surface of the package 4.

As illustrated in FIG. 1, the sensing unit 100 is provided outside the package 4 of the oscillator 10, and is connected to the oscillator 10 by the cable 15. For example, the cable 15 may be a coaxial cable, a flexible flat cable, or the like.

The sensing unit 100 includes a substrate 110 having a surface 110a and a surface 110b opposite to the surface 110a. Electrodes 101, 102, and 103 are provided on the surface 110a of the substrate 110. The electrodes 101, 102, and 103 each have an elongated rectangular shape, and the electrode 102 is located between the electrode 101 and the electrode 103. On the surface 110b of the substrate 110, an electrode 104 is provided at a position opposite to the arrangement region of the electrodes 101, 102, and 103 on the surface 110a. For example, the electrode 104 is provided on substantially the entire surface of the surface 110b.

The electrodes 101, 102, 103, and 104 are connected to external connection terminals of the oscillator 10 by wiring included in the cable 15. The electrodes 101, 102, 103, and 104 are therefore each connected to the terminals of the circuit device 2 via the external connection terminals of the oscillator 10.

In the present embodiment, the electrode 101 is a sensing electrode which can be connected to one of the XD terminal and the XG terminal of the circuit device 2, and the electrode 103 is a sensing electrode which can be connected to the other of the XD terminal and the XG terminal of the circuit device 2. The electrode 102 is an electrode having a fixed potential. For example, the electrode 102 is connected to the ground terminal of the circuit device 2, and the potential thereof is fixed to the ground potential. The electrode 104 is connected to the ground terminal of the circuit device 2, and the potential thereof is fixed to the ground potential.

The sensing unit 100 is disposed such that the electrodes 101, 102, and 103 face a detection target of the capacitance. A capacitance CD between the electrode 101 and the electrode 102 and a capacitance CG between the electrode 103 and the electrode 102 change according to the dielectric constant of the detection target.

As will be described later, when the electrode 101 is connected to the XD terminal of the circuit device 2 and the electrode 103 is connected to the XG terminal of the circuit device 2, if the capacitances CD and CG change, the load capacitance C_{L} of the resonator 3 also changes, and the oscillation frequency f of the oscillation circuit changes. Thus, the circuit device 2 measures the oscillation frequency f and outputs the measured value of the oscillation frequency f to the outside of the oscillator 10. An external device can determine the state of the detection target by detecting the change in the capacitances CD and CG based on the measured value of the oscillation frequency f. When an object that is not a detection target is positioned to face the surface 110b of the substrate 110, the electrode 104 functions as a shield member for reducing the influence of the object on the capacitances CD and CG.

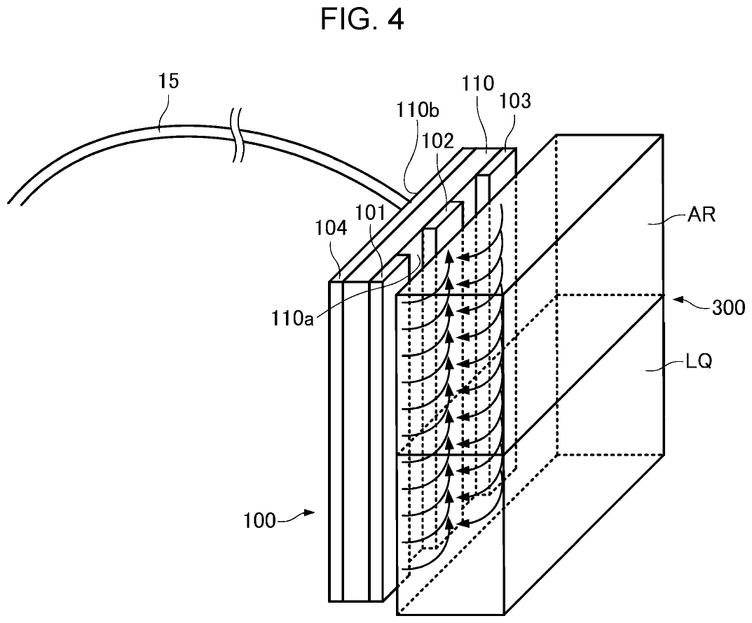

FIG. 4 is a diagram illustrating an example of use of the capacitance sensor 1. In the example of FIG. 4, the detection target 300 whose capacitance is to be detected is a container that accommodates liquid LQ. The internal space of the detection target 300 is filled with the liquid LQ and air AR, the air AR increases when the liquid LQ decreases, and the air AR decreases when the liquid LQ increases. The dielectric constant of the liquid LQ is several tens of times the dielectric constant of the air AR, and the effective dielectric constant inside the detection target 300 increases as the amount of the liquid LQ increases. On the other hand, the capacitances CD and CG increase or decrease in proportion to the dielectric constant of the detection target 300. Therefore, as the dielectric constant of the detection target 300 increases, that is, as the amount of the liquid LQ increases, the capacitances CD and CG increase, and thus the load capacitance C_{L} of the resonator 3 increases. Therefore, the external device can calculate the amount of the liquid LQ accommodated in the detection target 300 based on the measured value of the oscillation frequency f output from the oscillator 10.

### 1-2. Constitutive Configuration of Capacitance Sensor

FIG. 5 is a functional block diagram of the capacitance sensor 1 according to the first embodiment. As illustrated in FIG. 5, the capacitance sensor 1 of the first embodiment includes the circuit device 2 and the sensing unit 100.

The circuit device 2 includes a drive circuit 21, a buffer circuit 30, a measurement circuit 40, a clock generation circuit 50, a control circuit 60, a register 70, an interface circuit 80, a switch circuit 90, and reference capacitors 95 and 96. The circuit device 2 may have a configuration in which some of these components are not provided or changed, or other components are added.

The circuit device 2 includes a VDD terminal which is a power supply terminal and a VSS terminal which is a ground terminal, and each circuit operates with a potential of the VDD terminal as a power supply potential and a potential of the VSS terminal as a ground potential. In addition, the circuit device 2 includes the XD terminal and the XG terminal, and the XD terminal and the XG terminal are connected to both ends of the resonator 3. Further, the circuit device 2 has a terminal (not illustrated) for performing data communication with an MCU 200 which is an external device of the circuit device 2.

The drive circuit 21 is connected to the XD terminal and the XG terminal and generates an oscillation signal OSCO by vibrating the resonator 3. The drive circuit 21 amplifies the signal received from the resonator 3 via the XG terminal and outputs the amplified signal to the resonator 3 via the XD terminal. Accordingly, the two vibrating arms of the resonator 3 vibrate, and the drive circuit 21 outputs a signal received from the resonator 3 via the XG terminal as the oscillation signal OSCO. An oscillation circuit 20 is configured by the resonator 3 and the drive circuit 21.

The buffer circuit 30 buffers the oscillation signal OSCO output from the drive circuit 21 and outputs a square wave signal BFO. The square wave of the signal BFO includes not only a strict square wave but also a waveform close to a square wave.

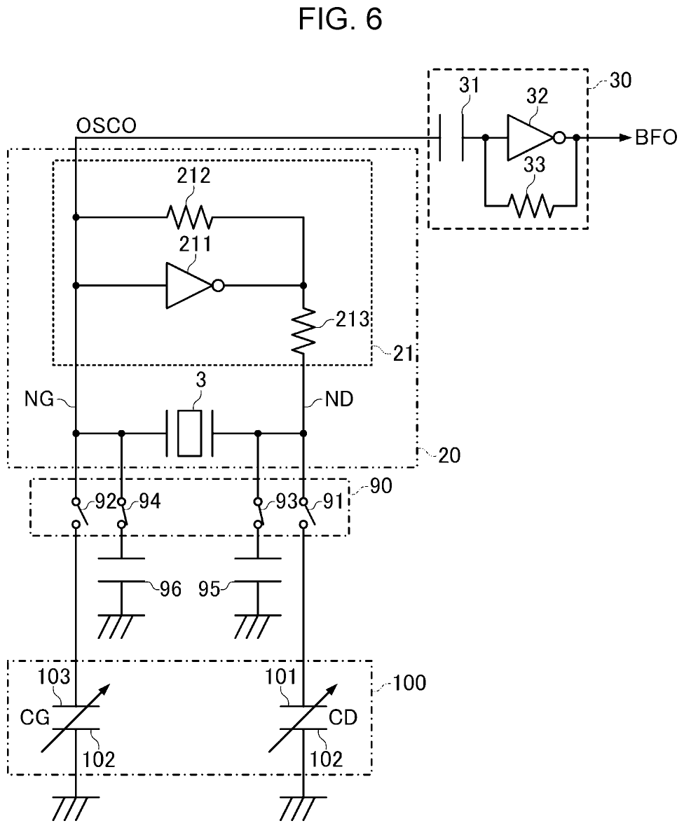

FIG. 6 is a diagram illustrating a configuration example of the drive circuit 21 and the buffer circuit 30. As illustrated in FIG. 6, the drive circuit 21 includes an amplifier 211 and resistors 212 and 213.

The amplifier 211 amplifies the signal output from the resonator 3 and outputs the amplified signal to the resonator 3 via the resistor 213. In the example of FIG. 6, the amplifier 211 is a CMOS inverter circuit, but may be a bipolar transistor.

The resonator 3 is connected between a node NG and a node ND. The node NG is an input node of the amplifier 211, and the signal output from the resonator 3 is input to the amplifier 211 from the node NG. The node ND is an output node of the amplifier 211, and the signal output from the amplifier 211 is output to the node ND via the resistor 213. The node NG is connected to the XG terminal, and the node ND is connected to the XD terminal.

The signal output from the amplifier 211 is a square wave signal, and the square wave signal is input to the resonator 3. As illustrated in FIGS. 2 and 3, the resonator 3 is, for example, a tuning fork type quartz crystal resonator or an AT cut quartz crystal resonator, and has a very high Q factor, and thus the signal output from the resonator 3 is a signal which has little noise and is close to a sine wave. The signal output from the resonator 3 to the node NG is input to the buffer circuit 30 as the oscillation signal OSCO. The square wave of the signal output from the amplifier 211 includes not only a strict square wave but also a waveform close to a square wave.

The buffer circuit 30 includes a capacitor 31, a CMOS inverter circuit 32, and a resistor 33. The oscillation signal OSCO is input to the CMOS inverter circuit 32 via the capacitor 31, and the CMOS inverter circuit 32 outputs the square wave signal BFO.

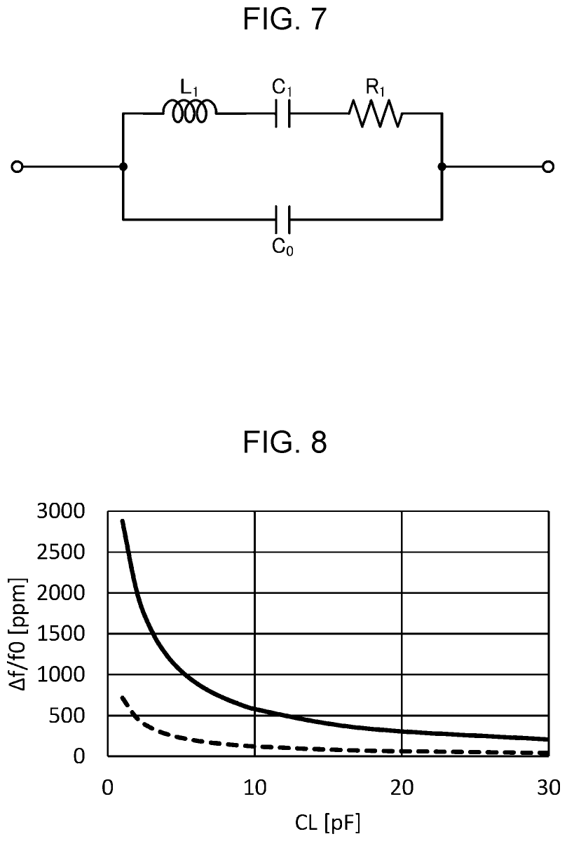

Here, FIG. 7 is a diagram illustrating an equivalent circuit of the resonator 3 which is a quartz crystal resonator, and examples of equivalent constants of the resonator 3 include a series inductance L₁, a series capacitance C₁, a series resistance R₁, and a parallel capacitance C₀. At this time, the series resonance frequency f₀ of the resonator 3 is expressed by Equation (1).

$${f}_{0} = \frac{1}{2 π} \sqrt{\frac{1}{{L}_{1} {C}_{1}}} \qquad ( 1 )$$

The oscillation frequency f of the oscillation circuit 20 configured by the resonator 3 and the drive circuit 21 varies depending on the load capacitance C_{L}, and a normalized frequency Δf/f₀ of the oscillation circuit 20 is expressed by Equation (2).

$$\frac{Δ f}{{f}_{0}} = \frac{f - {f}_{0}}{{f}_{0}} = \frac{1}{2 γ} \frac{1}{1 + \frac{{C}_{L}}{{C}_{0}}} \qquad ( 2 )$$

In Equation (2), γ is a ratio between the parallel capacitance C₀ and the series capacitance C₁ and is expressed by Equation (3).

$$γ = \frac{{C}_{0}}{{C}_{1}} \qquad ( 3 )$$

FIG. 8 is a graph illustrating an example of the relationship between the load capacitance C_{L} and the normalized frequency Δf/f₀. In FIG. 8, a solid line is a graph in a case where the resonator 3 is a tuning fork type quartz crystal resonator, and a dashed line is a graph in a case where the resonator 3 is an AT cut quartz crystal resonator. As can be seen from FIG. 8, when the load capacitance C_{L} changes in the range of 0 to 30 pF, the normalized frequency Δf/f₀ also changes, and the rate of change is larger in the tuning fork type quartz crystal resonator.

The switch circuit 90 switches between a state in which the electrode 101 of the sensing unit 100 is connected to one of the input node NG and the output node ND of the amplifier 211 and the electrode 103 of the sensing unit 100 is connected to the other of the input node NG and the output node ND of the amplifier 211, and a state in which one end of the reference capacitor 95 is connected to one of the input node NG and the output node ND of the amplifier 211 and one end of the reference capacitor 96 is connected to the other of the input node NG and the output node ND of the amplifier 211. In FIGS. 5 and 6, the switch circuit 90 switches between a state in which the electrode 101 is connected to the output node ND of the amplifier 211 and the electrode 103 is connected to the input node NG of the amplifier 211, and a state in which one end of the reference capacitor 95 is connected to the output node ND of the amplifier 211 and one end of the reference capacitor 96 is connected to the input node NG of the amplifier 211. That is, the node to which the electrode 101 or the reference capacitor 95 is connected is the output node ND, and the node to which the electrode 103 or the reference capacitor 96 is connected is the input node NG.

Specifically, the switch circuit 90 includes switches 91, 92, 93, and 94, one end of each of the switches 91 and 93 is connected to the output node ND, and one end of each of the switches 92 and 94 is connected to the input node NG. The other end of the switch 91 is connected to the electrode 101, and the other end of the switch 92 is connected to the electrode 103. The electrode 102 of the sensing unit 100 is connected to the ground. The other end of the switch 93 is connected to one end of the reference capacitor 95, and the other end of the switch 94 is connected to one end of the reference capacitor 96. The other ends of the reference capacitors 95 and 96 are connected to the ground. For example, the reference capacitors 95 and 96 may be capacitors. In addition, the reference capacitors 95 and 96 may be MOS capacitors, capacitors using a comb-shaped electrode or a parallel plate electrode, or the like in that they can be integrated in the circuit device 2, but a chip capacitor separate from the circuit device 2 can also be applied.

The switches 91 and 92 are turned on when a switch control signal ASW is at a low level, and are turned off when the switch control signal ASW is at a high level. The switches 93 and 94 are turned on when the switch control signal ASW is at a high level, and are turned off when the switch control signal ASW is at a low level. That is, the switches 91 and 92 and the switches 93 and 94 are turned on/off exclusively of each other. When the switches 91 and 92 are turned on, the electrode 101 is connected to the output node ND and the electrode 103 is connected to the input node NG. When the switches 93 and 94 are turned on, one end of the reference capacitor 95 is connected to the output node ND and one end of the reference capacitor 96 is connected to the input node NG.

Therefore, when the switches 91 and 92 are turned on, the load capacitance C_{L} of the resonator 3 is configured by the capacitance CD between the electrode 101 and the electrode 102 and the capacitance CG between the electrode 103 and the electrode 102, and is expressed by Equation (4). In Equation (4), CS is a stray capacitance, which is about several pF.

$${C}_{L} = \frac{CG \times CD}{CG + CD} + CS \qquad ( 4 )$$

According to Equations (1) to (4), when the electrode 101 is connected to the output node ND and the electrode 103 is connected to the input node NG, the oscillation frequency f of the oscillation circuit 20 changes according to the capacitances CD and CG. On the other hand, when the reference capacitor 95 is connected to the output node ND and the reference capacitor 96 is connected to the input node NG, the oscillation frequency f of the oscillation circuit 20 changes in accordance with the reference capacitors 95 and 96. The frequency of the oscillation signal OSCO output from the drive circuit 21 is the oscillation frequency f, and the frequency of the signal BFO output from the buffer circuit 30 also matches the oscillation frequency f. The control of the switches 91, 92, 93, and 94 by the switch control signal ASW from the control circuit 60 does not necessarily only control the switches 91 and 92 and the switches 93 and 94 to be turned on/off in a mutually exclusive manner, but may also control each of the four switches 91, 92, 93, and 94 independently.

As illustrated in FIG. 5, based on the signal BFO output from the buffer circuit 30, the measurement circuit 40 measures a first oscillation frequency f₁ of the oscillation circuit 20 when the electrode 101 is connected to the output node ND and the electrode 103 is connected to the input node NG, and measures a second oscillation frequency f₂ of the oscillation circuit 20 when one end of the reference capacitor 95 is connected to the output node ND and one end of the reference capacitor 96 is connected to the input node NG. Further, the measurement circuit 40 may calculate a ratio between the first oscillation frequency f₁ and the second oscillation frequency f₂. Since the first oscillation frequency f₁ and the second oscillation frequency f₂ are similarly affected by the temperature characteristics and the aging characteristics of the resonator 3 and the drive circuit 21, the influence of the temperature characteristics and the aging characteristics of the resonator 3 and the drive circuit 21 is reduced with respect to the ratio between the first oscillation frequency f₁ and the second oscillation frequency f₂.

For example, the measurement circuit 40 includes a frequency divider circuit 41, a counter 42, and a divider 43. The frequency divider circuit 41 divides the frequency of the signal BFO output from the buffer circuit 30, which is a signal based on the oscillation of the oscillation circuit 20, and outputs a gate time signal GT.

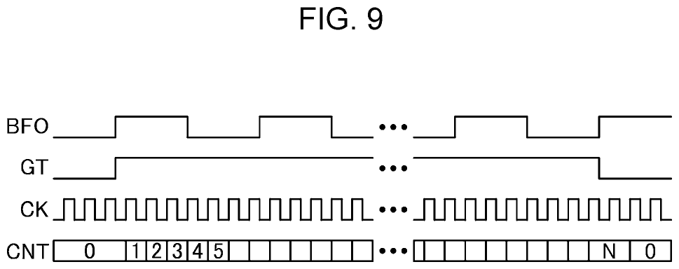

The counter 42 counts the number of pulses of the clock signal CK included in a gate time which is a period during which the gate time signal GT output from the frequency divider circuit 41 remains at a predetermined logic level, and the counter 42 outputs a count value CNT. For example, as illustrated in a timing chart of FIG. 9, the frequency divider circuit 41 outputs the gate time signal GT which remains at a high level for a time of a predetermined cycle of the signal BFO, and the counter 42 outputs the count value CNT of the number of pulses of the clock signal CK included in a period during which the gate time signal GT remains at a high level. In this case, the time during which the gate time signal GT remains at a high level corresponds to the gate time.

The count value CNT corresponds to a ratio between the frequency of the clock signal CK and the frequency of the signal BFO, and the count value CNT decreases as the frequency of the signal BFO increases. That is, the frequency of the signal BFO and the count value CNT have a one-to-one relationship, and the count value CNT corresponds to the frequency of the signal BFO, that is, the measured value of the oscillation frequency f.

The longer the gate time, the higher the measurement resolution of the measurement circuit 40, but the longer the time required for the measurement. Therefore, the gate time is appropriately set according to the upper limit value of the allowable measurement time, and is set to, for example, several hundred milliseconds.

When the switch control signal ASW is at a low level, that is, when the switches 91 and 92 are turned on, the counter 42 counts the number of pulses of the clock signal CK included in the gate time and outputs a count value CNT₁. Further, when the switch control signal ASW is at a high level, that is, when the switches 93 and 94 are turned on, the counter 42 counts the number of pulses of the clock signal CK included in the gate time and outputs a count value CNT₂. The count value CNT₁ corresponds to a measured value of the first oscillation frequency f₁, and the count value CNT₂ corresponds to a measured value of the second oscillation frequency f₂.

The divider 43 calculates a ratio between the first oscillation frequency f₁ and the second oscillation frequency f₂ by dividing the count value CNT₁ output from the counter 42 by the count value CNT₂. The ratio between the first oscillation frequency f₁ and the second oscillation frequency f₂ is stored in the register 70.

Further, the measurement circuit 40 may measure each of the first oscillation frequency f₁ and the second oscillation frequency f₂ a plurality of times and calculate the ratio between the average value of the first oscillation frequency f₁ and the average value of the second oscillation frequency f₂. In this case, the counter 42 performs a plurality of times a process of counting the number of pulses of the clock signal CK included in the gate time when the switch control signal ASW is at a low level and outputting the count value CNT₁. Further, the counter 42 performs a plurality of times a process of counting the number of pulses of the clock signal CK included in the gate time when the switch control signal ASW is at a high level and outputting the count value CNT₂. Then, the divider 43 calculates the average value of the plurality of count values CNT₁ and the average value of the plurality of count values CNT₂, and divides the average value of the count values CNT₁ by the average value of the count values CNT₂ to calculate the ratio between the average value of the first oscillation frequency f₁ and the average value of the second oscillation frequency f₂. The ratio between the average value of the first oscillation frequency f₁ and the average value of the second oscillation frequency f₂ is stored in the register 70.

The count value CNT₁ or the count value CNT₂ may be stored in the register 70, or the average value of the count values CNT₁ or the average value of the count values CNT₂ may be stored in the register 70.

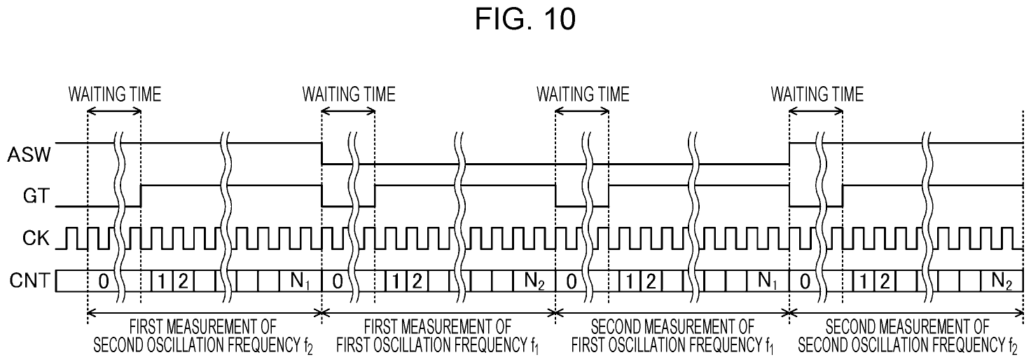

As illustrated in FIG. 10, for example, the measurement circuit 40 may measure the second oscillation frequency f₂ once, then measure the first oscillation frequency f₁ twice, then measure the second oscillation frequency f₂ once, and calculate the ratio between the average value of the first oscillation frequency f₁ and the average value of the second oscillation frequency f₂.

When the temperature rises or falls between the four measurements, each measured value will contain an error caused by the temperature change. However, when the measurements are performed in the order illustrated in FIG. 10, the measurement error tends to increase or decrease in the order of the first measurement of the second oscillation frequency f₂, the first measurement of the first oscillation frequency f₁, the second measurement of the first oscillation frequency f₁, and the second measurement of the second oscillation frequency f₂. Therefore, since the difference between errors included in the average value of the first oscillation frequency f₁ and errors included in the average value of the second oscillation frequency f₂ becomes small, the measurement accuracy is improved.

When the switches 91 and 92 are switched from ON to OFF or from OFF to ON, the oscillation of the oscillation circuit 20 may become unstable or the oscillation may stop. Therefore, as illustrated in FIG. 10, the measurement circuit 40 may provide a waiting time between a measurement of the first oscillation frequency f₁ or the second oscillation frequency f₂ and the subsequent measurement of the first oscillation frequency f₁ or the second oscillation frequency f₂. By providing such a waiting time, even if the oscillation of the oscillation circuit 20 becomes unstable or the oscillation stops, the measurement is not adversely affected.

In FIG. 10, the switches 91 and 92 remain ON from the end of the first measurement of the first oscillation frequency f₁ to the start of the second measurement of the first oscillation frequency f₁, and the oscillation of the oscillation circuit 20 does not become unstable; therefore, the waiting time is not necessarily be provided.

The clock signal CK is output from the clock generation circuit 50. As the frequency of the clock signal CK increases, the measurement resolution of the measurement circuit 40 increases. Therefore, for example, the clock generation circuit 50 may be a ring oscillator capable of outputting a signal of several tens of MHz to several hundreds of MHz. In addition, the clock signal CK from the clock generation circuit 50 may be output during a gate time which is a period during which the gate time signal GT remains at a predetermined logic level, for example, during a gate time which is the period during which the gate time signal GT remains at a high level. Therefore, while the capacitance sensor 1 is operating, the clock signal CK may be continuously output from the clock generation circuit 50, but a period in which the output of the clock signal CK from the clock generation circuit 50 is stopped may be provided outside the gate time. In this case, it is possible to reduce power consumption of the capacitance sensor 1.

The control circuit 60 controls the operation of the oscillation circuit 20. For example, the control circuit 60 outputs an enable signal to the oscillation circuit 20, and the oscillation circuit 20 oscillates when the enable signal remains at a high level and stops the oscillation when the enable signal remains at a low level. The control circuit 60 controls the operation of the measurement circuit 40. For example, the control circuit 60 outputs a signal instructing the measurement circuit 40 to start measurement, and the measurement circuit 40 performs a measurement process in response to the signal instructing the measurement circuit 40 to start measurement. The control circuit 60 generates a switch control signal ASW and outputs the switch control signal ASW to the switch circuit 90 and the measurement circuit 40.

The interface circuit 80 is a circuit for performing data communication with the MCU 200. For example, when the interface circuit 80 receives a measurement request from the MCU 200, the interface circuit 80 rewrites a predetermined bit of the register 70 from 0 to 1. When the control circuit 60 detects that the bit has been rewritten, the control circuit 60 causes the oscillation circuit 20 to start an oscillation operation, and outputs a signal for instructing the measurement circuit 40 to start measurement after a predetermined waiting time elapses.

In addition, for example, when the interface circuit 80 receives a reading request of the measured value from the MCU 200, the interface circuit 80 reads the ratio between the first oscillation frequency f₁ and the second oscillation frequency f₂ or the ratio between the average value of the first oscillation frequency f₁ and the average value of the second oscillation frequency f₂ stored in the register 70 and transmits the ratio to the MCU 200. The MCU 200 may calculate the load capacitance C_{L} based on the ratio or determine the state of the detection target. Alternatively, the interface circuit 80 may read out the count values CNT₁ and CNT₂ and the respective average values of the count values CNT₁ and CNT₂ stored in the register 70 and transmit the read values to the circuit MCU 200, and the circuit MCU 200 may calculate the load capacitance C₁ based on the values or may determine the state of the detection target.

The interface circuit 80 may be, for example, an interface circuit of an SPI bus or an interface circuit of an I²C bus. SPI is an abbreviation for serial peripheral interface, and I²C is an abbreviation for inter-integrated circuit.

The electrode 101 is an example of a “first electrode”, the electrode 102 is an example of a “second electrode”, the electrode 103 is an example of a “third electrode”, and the electrode 104 is an example of a “ground electrode”. The capacitance CD is an example of a “first capacitance”, and the capacitance CG is an example of a “second capacitance”. The reference capacitor 95 is an example of a “first reference capacitor”, and the reference capacitor 96 is an example of a “second reference capacitor”. The output node ND of the amplifier 211 is an example of a “first node”, and the input node NG of the amplifier 211 is an example of a “second node”. The surface 110a of the substrate 110 is an example of a “first surface”, and the surface 110b of the substrate 110 is an example of a “second surface”.

### 1-3. Function and Effect

In the capacitance sensor 1 of the first embodiment as described above, when the electrodes 101 and 103 are connected to the nodes ND and NG, respectively, the oscillation circuit 20 oscillates based on the resonance due to the resonator 3 and the capacitances CD and CG rather than the CR oscillation based on the charging and discharging of the capacitances CD and CG, thereby being less likely to be affected by external amplitude noise. Therefore, according to the capacitance sensor 1 of the first embodiment, it is possible to detect the capacitance with high accuracy.

In the capacitance sensor 1 according to the first embodiment, when the interval between the period in which the electrodes 101 and 103 are connected to the nodes ND and NG, respectively, and the period in which one end of each of the reference capacitors 95 and 96 is connected to each of the nodes ND and NG, respectively, is short, the first oscillation frequency f₁ measured in the former period and the second oscillation frequency f₂ measured in the latter period are similarly affected by the temperature characteristics and aging characteristics of the oscillation circuit 20. Therefore, according to the capacitance sensor 1 of the first embodiment, the measurement circuit 40 calculates the ratio between the first oscillation frequency f₁ and the second oscillation frequency f₂, thereby obtaining a highly accurate oscillation frequency in which the influence of the temperature or aging of the oscillation circuit 20 is reduced, and thus the MCU 200 can calculate the capacitance with high accuracy based on the oscillation frequency. Furthermore, the measurement circuit 40 calculates the ratio between the average value of the first oscillation frequency f₁ measured a plurality of times and the average value of the second oscillation frequency f₂ measured a plurality of times, thereby obtaining a highly accurate oscillation frequency in which not only the influence of the temperature and aging of the oscillation circuit 20 but also the influence of, for example, noise and instantaneous temperature change is reduced, and thus the MCU 200 can calculate the capacitance with higher accuracy based on the oscillation frequency.

In the capacitance sensor 1 of the first embodiment, when the electrodes 101 and 103 are connected to the nodes ND and NG, respectively, the oscillation frequency of the oscillation circuit 20 changes according to the capacitances CD and CG, and it is thus possible to widen the variable width of the oscillation frequency compared to a case where there is no capacitance CG, that is, a case where the electrode 103 is not provided in the sensing unit 100. Therefore, according to the capacitance sensor 1 of the first embodiment, it is possible to improve the detection sensitivity of the capacitance.

In the capacitance sensor 1 according to the first embodiment, since the resonator 3 has a very high Q factor and therefore also functions as a noise filter, and the signal output from the resonator 3 to the input node NG of the amplifier 211 is a signal with little noise and close to a sine wave. Therefore, according to the capacitance sensor 1 of the first embodiment, since a spike due to noise does not occur in the output signal of the buffer circuit 30, the risk that the measurement circuit 40 performs erroneous measurement is reduced.

In the capacitance sensor 1 of the first embodiment, since the electrode 104 is provided on the surface 110b of the substrate 110 at the position opposite to the arrangement region of the electrodes 101, 102, and 103 on the surface 110a, when an object not being a detection target is located to face the surface 110b, the influence of the object on the capacitances CD and CG is reduced. Therefore, according to the capacitance sensor 1 of the first embodiment, it is possible to improve the detection accuracy of the capacitance.

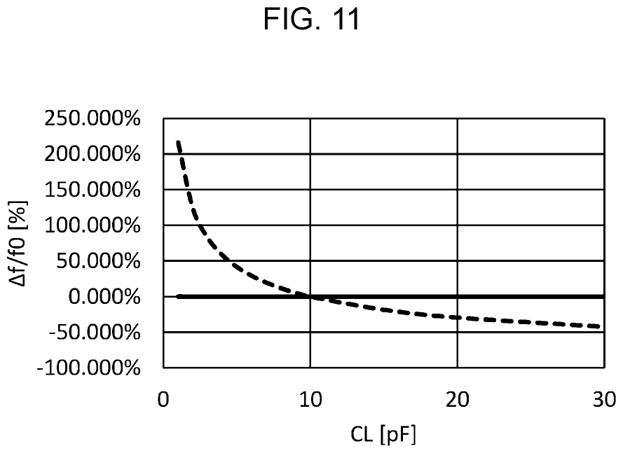

Meanwhile, as illustrated in FIG. 11, an LC oscillation circuit using LC resonance due to inductors and capacitances has a wider variable width of the oscillation frequency compared to an oscillation circuit using a resonator and a capacitance. FIG. 11 is a graph illustrating an example of a relationship between a load capacitance C_{L} and a normalized frequency Δf/f₀. A solid line is a graph in a case where the resonator 3 is a tuning fork type quartz crystal resonator, and corresponds to the solid line graph in FIG. 8. A broken line is a graph in a case of an LC oscillation circuit. It can be seen from FIG. 11 that the variable width of the oscillation circuit using the resonator and the capacitance is extremely narrow compared to the variable width of the oscillation frequency of the LC oscillation circuit.

Therefore, it is also conceivable to configure a capacitance sensor with high detection sensitivity using an LC oscillation circuit. However, for example, in a case where the capacitance sensor using the LC oscillation circuit detects the capacitance of the order of pF, when a small-sized inductor of the order of nH is used to reduce costs, the oscillation frequency becomes of the order of GHz, which may cause various problems, for example, an increase in the size and power consumption of the circuit that measures the capacitance. On the other hand, it is necessary to use a large-sized inductor of the order of pH to set the oscillation frequency of the order of MHz, which becomes an obstacle to the reduction in size and cost of the capacitance sensor.

In contrast, in the capacitance sensor 1 of the present embodiment, the oscillation circuit 20 using the resonator 3 and the capacitances CD and CG has a much narrower variable width of the oscillation frequency than the LC oscillation circuit, but can easily achieve an oscillation frequency of the order of kHz or MHz using the small-sized resonator 3, and for example, with respect to the capacitance of the order of pF, as illustrated in FIG. 8, a practically necessary variable width of the oscillation frequency can be obtained. Further, since the inductance value of the inductor is determined by a size, it is difficult to reduce the size of the inductor without changing the inductance value, but the resonator 3 can be reduced in size and costs with future advances in a manufacturing process. Therefore, according to the capacitance sensor 1 of the first embodiment, since it is possible to achieve the reduction in size and cost compared to a capacitance sensor using an LC oscillation circuit, for example, it can be easily used even when the detection target is a small object.

### 2. Second Embodiment

Hereinafter, regarding the second embodiment, the same reference numerals will be assigned to the same components as those of the first embodiment, the same description as that of the first embodiment will be omitted or simplified, and contents different from those of the first embodiment will be mainly described.

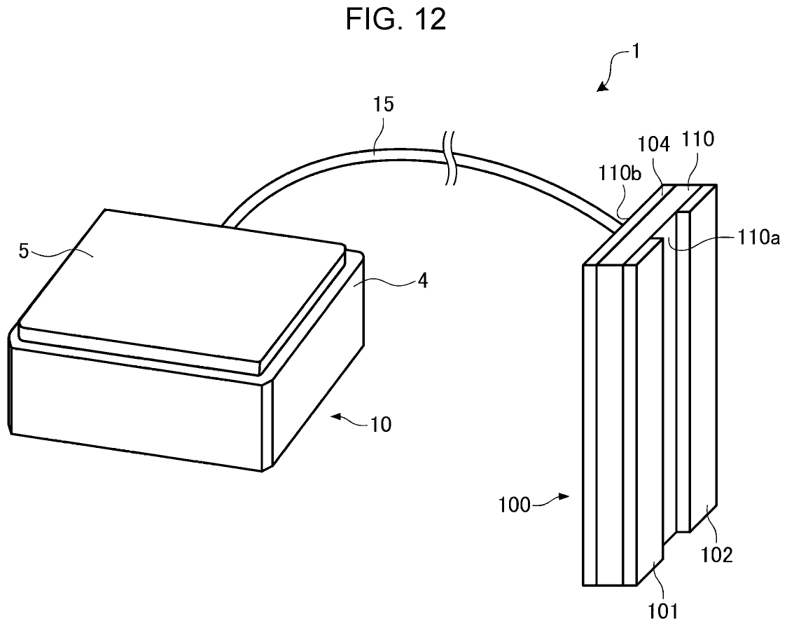

FIG. 12 is a diagram illustrating an appearance of a capacitance sensor 1 of the second embodiment. As illustrated in FIG. 12, the capacitance sensor 1 of the second embodiment includes an oscillator 10, a sensing unit 100, and a cable 15 that connects the oscillator 10 and the sensing unit 100, similarly to the capacitance sensor 1 of the first embodiment. The oscillator 10 has the same structure as the first embodiment, and thus will not be illustrated and described.

As illustrated in FIG. 12, the sensing unit 100 is provided outside a package 4 of the oscillator 10 and is connected to the oscillator 10 by the cable 15. For example, the cable 15 may be a coaxial cable, a flexible flat cable, or the like.

The sensing unit 100 includes a substrate 110 having a surface 110a and a surface 110b opposite to the surface 110a. Electrodes 101 and 102 are provided on the surface 110a of the substrate 110. On the surface 110b of the substrate 110, an electrode 104 is provided at a position opposite to the arrangement region of the electrodes 101 and 102 on the surface 110a. For example, the electrode 104 is provided on substantially the entire surface of the surface 110b.

The electrodes 101, 102, and 104 are connected to external connection terminals of the oscillator 10 by wiring included in the cable 15. The electrodes 101, 102, and 104 are therefore each connected to the terminals of a circuit device 2 via the external connection terminals of the oscillator 10.

In the present embodiment, the electrode 101 is a sensing electrode which can be connected to an XD terminal of the circuit device 2, and the electrode 102 is an electrode having a fixed potential. For example, the electrode 102 is connected to a VSS terminal which is the ground terminal of the circuit device 2, and the potential thereof is fixed to the ground potential. The electrode 104 is connected to the VSS terminal of the circuit device 2, and the potential thereof is fixed to the ground potential.

The sensing unit 100 is disposed such that the electrodes 101 and 102 face the detection target of the capacitance. A capacitance CD between the electrode 101 and the electrode 102 changes according to a dielectric constant of the detection target.

When the electrode 101 is connected to the XD terminal of the circuit device 2, if the capacitance CD changes, a load capacitance C_{L} of a resonator 3 also changes, and an oscillation frequency f of an oscillation circuit 20 changes. Thus, the circuit device 2 measures the oscillation frequency f and outputs the measured value of the oscillation frequency f to the outside of the oscillator 10. An external device can determine a state of the detection target by detecting the change in the capacitance CD based on the measured value of the oscillation frequency f. When an object not being a detection target is located to face the surface 110b of the substrate 110, the electrode 104 functions as a shield member for reducing the influence of the object on the capacitance CD.

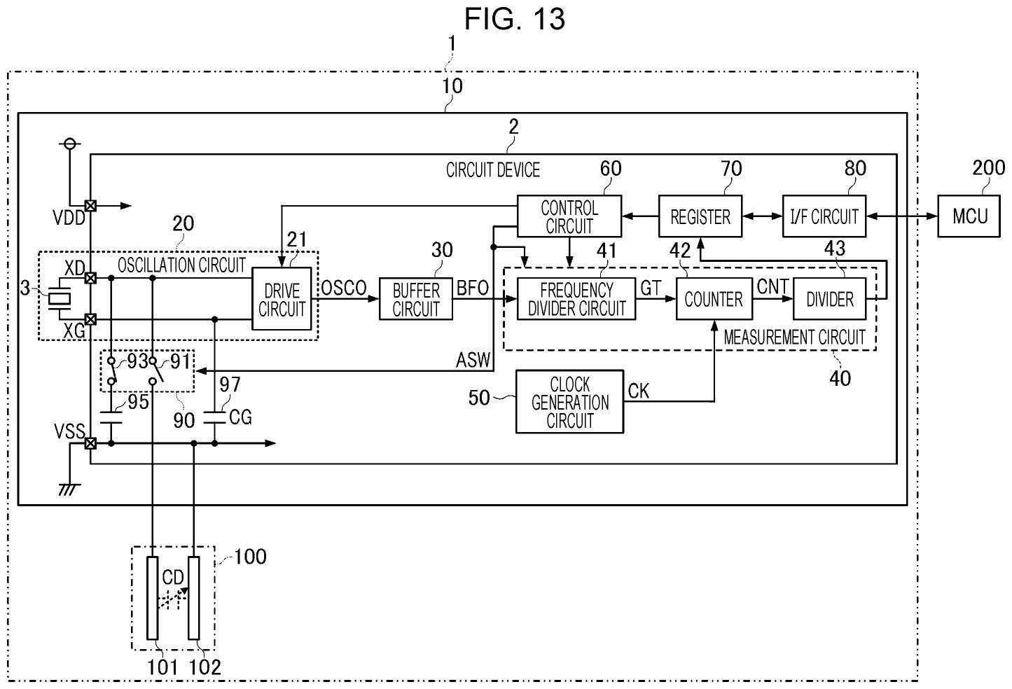

FIG. 13 is a functional block diagram of the capacitance sensor 1 according to the second embodiment. As illustrated in FIG. 13, the capacitance sensor 1 of the second embodiment includes the circuit device 2 and the sensing unit 100, similarly to the capacitance sensor 1 of the first embodiment.

As in the first embodiment, the circuit device 2 includes a drive circuit 21, a buffer circuit 30, a measurement circuit 40, a clock generation circuit 50, a control circuit 60, a register 70, an interface circuit 80, a switch circuit 90, and a reference capacitor 95, and further includes a capacitor 97 instead of the reference capacitor 96. The circuit device 2 may have a configuration in which some of these components are not provided or changed, or other components are added.

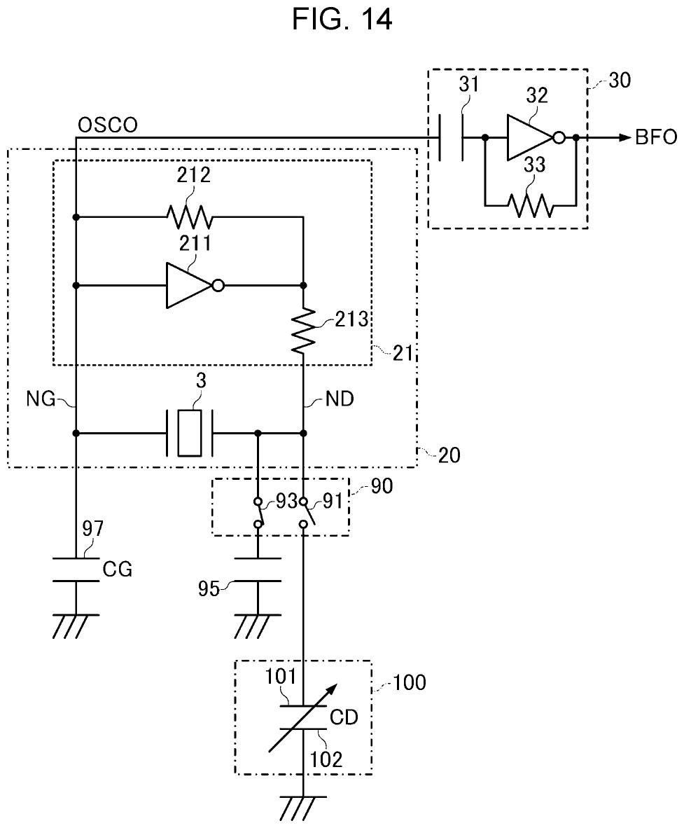

FIG. 14 is a diagram illustrating a configuration example of the drive circuit 21 and the buffer circuit 30 according to the second embodiment. As illustrated in FIG. 14, the drive circuit 21 includes an amplifier 211 and resistors 212 and 213, similarly to the first embodiment. Moreover, the buffer circuit 30 includes a capacitor 31, a CMOS inverter circuit 32, and a resistor 33, similarly to the first embodiment. The drive circuit 21, the buffer circuit 30, the clock generation circuit 50, the control circuit 60, the register 70, and the interface circuit 80 have the same configuration and function as those in the first embodiment, and thus will not be described.

The switch circuit 90 switches between connecting the electrode 101 of the sensing unit 100 to and connecting one end of the reference capacitor 95 to one of an input node NG and an output node ND of the amplifier 211. In addition, one end of the capacitor 97 is connected to the other of the input node NG and the output node ND of the amplifier 211, and the other end of the capacitor 97 is connected to the ground. In FIGS. 13 and 14, the switch circuit 90 switches between connecting the electrode 101 to and connecting one end of the reference capacitor 95 to the output node ND of the amplifier 211, and one end of the capacitor 97 is connected to the input node NG of the amplifier 211. That is, the node to which the electrode 101 or the reference capacitor 95 is connected is the output node ND.

Since the capacitor 97 is built in the circuit device 2 and is not formed in the sensing unit 100, a capacitance CG of the capacitor 97 is a constant value. The capacitance CG is, for example, several pF to several tens of pF. It is sufficient that the capacitor 97 is provided inside the package 4, and the capacitor 97 may be provided outside the circuit device 2.

The switch circuit 90 includes switches 91 and 93, and one end of each of the switches 91 and 93 is connected to the output node ND. The other end of the switch 91 is connected to the electrode 101, and the other end of the switch 93 is connected to one end of the reference capacitor 95. The other end of the reference capacitor 95 is connected to the ground. The electrode 102 of the sensing unit 100 is connected to the ground. For example, the reference capacitor 95 may be a capacitor.

The switch 91 is turned on when a switch control signal ASW is at a low level, and is turned off when the switch control signal ASW is at a high level. The switch 93 is turned on when the switch control signal ASW is at a high level, and is turned off when the switch control signal ASW is at a low level. That is, the switch 91 and the switch 93 are turned on/off exclusively of each other. When the switch 91 is turned on, the electrode 101 is connected to the output node ND, and when the switch 93 is turned on, one end of the reference capacitor 95 is connected to the output node ND.

Therefore, when the switch 91 is turned on, the load capacitance C_{L} of the resonator 3 is constituted by the capacitance CD between the electrodes 101 and 102 and the capacitance CG of the capacitor 97, and is expressed by Equation (4) described above. Then, the oscillation frequency f of the oscillation circuit 20 changes according to the capacitance CD from Equations (1) to (4) described above. The control of the switches 91 and 93 by the switch control signal ASW from the control circuit 60 does not necessarily only control the switches 91 and 93 to be turned on/off in a mutually exclusive manner, but may also control each of the switches 91 and 93 independently.

Based on a signal BFO output from the buffer circuit 30, the measurement circuit 40 measures a first oscillation frequency f₁ of the oscillation circuit 20 when the electrode 101 is connected to the output node ND, and measures a second oscillation frequency f₂ of the oscillation circuit 20 when one end of the reference capacitor 95 is connected to the output node ND. Further, the measurement circuit 40 may calculate a ratio between the first oscillation frequency f₁ and the second oscillation frequency f₂. Since the first oscillation frequency f₁ and the second oscillation frequency f₂ are similarly affected by the temperature characteristics and the aging characteristics of the resonator 3 and the drive circuit 21, the influence of the temperature characteristics and the aging characteristics of the resonator 3 and the drive circuit 21 is reduced with respect to the ratio between the first oscillation frequency f₁ and the second oscillation frequency f₂.

For example, the measurement circuit 40 includes a frequency divider circuit 41, a counter 42, and a divider 43. The frequency divider circuit 41 divides a frequency of the signal BFO output from the buffer circuit 30 and outputs a gate time signal GT.

When the switch control signal ASW is at a low level, that is, when the switch 91 is turned on, the counter 42 counts the number of pulses of a clock signal CK included in a gate time which is a period in which the gate time signal GT is at a predetermined logic level, for example, a high level, and outputs a count value CNT₁. Further, when the switch control signal ASW is at a high level, that is, when the switch 93 is turned on, the counter 42 counts the number of pulses of the clock signal CK included in the gate time and outputs a count value CNT₂. The count value CNT₁ corresponds to a measured value of the first oscillation frequency f₁, and the count value CNT₂ corresponds to a measured value of the second oscillation frequency f₂. The divider 43 calculates a ratio between the first oscillation frequency f₁ and the second oscillation frequency f₂ by dividing the count value CNT₁ output from the counter 42 by the count value CNT₂. The ratio between the first oscillation frequency f₁ and the second oscillation frequency f₂ is stored in the register 70.

As in the first embodiment, the measurement circuit 40 may measure each of the first oscillation frequency f₁ and the second oscillation frequency f₂ a plurality of times and calculate the ratio between the average value of the first oscillation frequency f₁ and the average value of the second oscillation frequency f₂.

The count value CNT₁ or the count value CNT₂ may be stored in the register 70, or the average value of the count values CNT₁ or the average value of the count values CNT₂ may be stored in the register 70.

Other components and operations of the capacitance sensor 1 of the second embodiment are the same as those of the capacitance sensor 1 of the first embodiment, and thus will not be described.

The electrode 101 is an example of a “first electrode”, the electrode 102 is an example of a “second electrode”, and the electrode 104 is an example of a “ground electrode”. The capacitance CD is an example of a “first capacitance”, and the reference capacitor 95 is an example of a “first reference capacitor”. The output node ND of the amplifier 211 is an example of a “first node”. The surface 110a of the substrate 110 is an example of a “first surface”, and the surface 110b of the substrate 110 is an example of a “second surface”.

In the capacitance sensor 1 of the second embodiment as described above, when the electrode 101 is connected to the node ND, the oscillation circuit 20 oscillates based on the resonance due to the resonator 3 and the capacitance CD rather than the CR oscillation based on the charging and discharging of the capacitance CD, thereby being less likely to be affected by external amplitude noise. Therefore, according to the capacitance sensor 1 of the second embodiment, it is possible to detect the capacitance with high accuracy.

In the capacitance sensor 1 according to the second embodiment, when the interval between the period in which the electrode 101 is connected to the node ND and the period in which one end of the reference capacitor 95 is connected to the node ND is short, the first oscillation frequency f₁ measured in the former period and the second oscillation frequency f₂ measured in the latter period are similarly affected by the temperature characteristics and aging characteristics of the oscillation circuit 20. Therefore, according to the capacitance sensor 1 of the second embodiment, the measurement circuit 40 calculates the ratio between the first oscillation frequency f₁ and the second oscillation frequency f₂, thereby obtaining a highly accurate oscillation frequency in which the influence of the temperature or aging of the oscillation circuit 20 is reduced, and thus the MCU 200 can calculate the capacitance with high accuracy based on the oscillation frequency. Furthermore, the measurement circuit 40 calculates the ratio between the average value of the first oscillation frequency f₁ measured a plurality of times and the average value of the second oscillation frequency f₂ measured a plurality of times, thereby obtaining a highly accurate oscillation frequency in which not only the influence of the temperature and aging of the oscillation circuit 20 but also the influence of, for example, noise and instantaneous temperature change is reduced, and thus the MCU 200 can calculate the capacitance with higher accuracy based on the oscillation frequency.

In the capacitance sensor 1 according to the second embodiment, since the resonator 3 has a very high Q factor and therefore also functions as a noise filter, noise received from the electrode 101 of the sensing unit 100 connected to the output node ND of the amplifier 211 is greatly reduced by the resonator 3, and the signal output from the resonator 3 to the input node NG of the amplifier 211 is a signal with little noise and close to a sine wave. Therefore, according to the capacitance sensor 1 of the second embodiment, the risk that the detection accuracy is reduced due to the noise received from the electrode 101 is reduced.

In the capacitance sensor 1 of the second embodiment, since the electrode 104 is provided on the surface 110b of the substrate 110 at the position opposite to the arrangement region of the electrodes 101 and 102 on the surface 110a, when an object not being a detection target is located to face the surface 110b, the influence of the object on the capacitance CD is reduced. Therefore, according to the capacitance sensor 1 of the second embodiment, it is possible to improve the detection accuracy of the capacitance.

In addition, according to the capacitance sensor 1 of the second embodiment, since it is possible to achieve the reduction in size and cost compared to a capacitance sensor using an LC oscillation circuit, for example, it can be easily used even when the detection target is a small object.

### 3. Modifications

The present disclosure is not limited to the present embodiments, and various modifications can be made within the scope of the spirit of the present disclosure.

In the second embodiment described above, for example, the switch circuit 90 switches between connecting the electrode 101 to and connecting one end of the reference capacitor 95 to the output node ND of the amplifier 211, but may switch between connecting the electrode 101 to and connecting one end of the reference capacitor 95 to the input node NG of the amplifier 211. That is, one end of each of the switches 91 and 93 may be connected to the input node NG, the other end of the switch 91 may be connected to the electrode 101, the other end of the switch 93 may be connected to one end of the reference capacitor 95, and one end of the capacitor 97 may be connected to the output node ND.

In each of the embodiments described above, the circuit device 2 measures the oscillation frequency f based on the signal BFO and outputs the measured value of the oscillation frequency f to the outside of the oscillator 10, but may output the signal BFO to the outside. The external device may measure the oscillation frequency f of the signal BFO and calculate the value of the load capacitance C_{L} based on the measured value of the oscillation frequency f. In this case, the circuit device 2 does not necessarily include the measurement circuit 40. Alternatively, the circuit device 2 may calculate the value of the load capacitance C_{L} based on the oscillation frequency f and output the value of the load capacitance C_{L} to the outside.

In addition, the oscillator 10 of each of the embodiments described above is a simple oscillator such as an SPXO, but may be an oscillator such as a TCXO having a temperature compensation function, or may be an oscillator such as a VCXO having a frequency control function. SPXO is an abbreviation for Simple Packaged Crystal Oscillator. TCXO is an abbreviation for Temperature Compensated Crystal Oscillator. VCXO is an abbreviation for Voltage Controlled Crystal Oscillator. The oscillator 10 may be an oscillator such as a VC-TCXO having a temperature compensation function and a frequency control function, or may be an oscillator such as an OCXO having a temperature control function. VC-TCXO is an abbreviation for Voltage Controlled Temperature Compensated Crystal Oscillator. Further, OCXO is an abbreviation for Oven Controlled Crystal Oscillator.

In each of the embodiments described above, an example has been described in which the capacitance sensor 1 is used as a sensor for detecting the amount of liquid in a container, but the capacitance sensor 1 can also be used as, for example, a proximity sensor for detecting the approach of a detection target, a touch sensor for detecting the contact of a detection target, and various sensors for detecting rain, fog, ice, snow, gas, and the like. For example, during opening and closing of a door of a vehicle, the capacitance sensor 1 can also be used as a sensor that detects the approach or contact of a finger to the door and outputs an unlocking signal of the door. The capacitance sensor 1 can also be used as a sensor that determines not only the amount, approach, and contact of a detection target, but also the type of a detection target, liquid concentration, and the like.

The above-described embodiments and modifications are merely examples, and the present disclosure is not limited thereto. For example, each of the embodiments and each of the modifications may be combined as appropriate.

The present disclosure includes a configuration substantially the same as the configuration described in the embodiment, for example, a configuration having the same function, method, and result, or a configuration having the same purpose and effect. Further, the present disclosure includes configurations in which non-essential portions of the configuration described in the embodiments are replaced. In addition, the present disclosure includes configurations that provide the same effects as the configurations described in the embodiment or includes configurations that can achieve the same purpose as the configurations described in the embodiment. Further, the present disclosure includes configurations in which a known technology is added to the configurations described in the embodiment.

The following contents are derived from the above-described embodiments and modifications.

According to an aspect of the disclosure, there is provided a capacitance sensor including a package; an oscillation circuit provided inside the package; a switch circuit provided inside the package; a first reference capacitor provided inside the package; and a first electrode and a second electrode provided outside the package, the oscillation circuit includes an amplifier and a resonator provided inside the package and connected between an input node and an output node of the amplifier, the first electrode is an electrode for sensing, the second electrode is an electrode having a fixed potential, the switch circuit switches between connecting the first electrode to and connecting one end of the first reference capacitor to a first node which is one of the input node and the output node of the amplifier, and an oscillation frequency of the oscillation circuit changes according to a first capacitance between the first electrode and the second electrode when the first electrode is connected to the first node.

In the capacitance sensor, when the first electrode is connected to the first node, the oscillation circuit oscillates based on the resonance by the resonator and the first capacitance rather than CR oscillation based on charging and discharging of the first capacitance between the first electrode and the second electrode, thereby being less likely to be affected by external amplitude noise. Therefore, according to the capacitance sensor, it is possible to detect the capacitance with high accuracy.

In the capacitance sensor, when the interval between the period in which the first electrode is connected to the first node and the period in which one end of the reference capacitor is connected to the first node is short, the oscillation frequency of the oscillation circuit is similarly affected by the temperature characteristics or the aging characteristics of the oscillation circuit in both periods. Therefore, according to the capacitance sensor, for example, the external device corrects the oscillation frequency in the former period based on the oscillation frequency in the latter period, thereby obtaining a highly accurate oscillation frequency in which the influence of the temperature or aging of the oscillation circuit is reduced, and it is thus possible to calculate the capacitance with high accuracy based on the oscillation frequency.

Meanwhile, since an LC oscillation circuit using LC resonance due to an inductor and a capacitance has a wide variable width of the oscillation frequency compared to an oscillation circuit using a resonator and a capacitance, it is also considered to configure a capacitance sensor having high detection sensitivity using the LC oscillation circuit. However, for example, in a case where the capacitance sensor using the LC oscillation circuit detects the capacitance of the order of pF, when a small-sized inductor of the order of nH is used to reduce costs, the oscillation frequency becomes of the order of GHz, which may cause various problems, for example, an increase in the size and power consumption of the circuit that measures the capacitance. On the other hand, it is necessary to use a large-sized inductor of the order of pH to set the oscillation frequency of the order of MHz, which becomes an obstacle to the reduction in size and cost of the capacitance sensor.

In contrast, the oscillation circuit using the resonator and the capacitance has a much narrower variable width of the oscillation frequency than the LC oscillation circuit, but can easily achieve an oscillation frequency of the order of kHz or MHz using the small-sized resonator, and for example, with respect to the capacitance of the order of pF, a practically necessary variable width of the oscillation frequency can be obtained. Further, since the inductance value of the inductor is determined by a size, it is difficult to reduce the size of the inductor without changing the inductance value, but the resonator can be reduced in size and costs with future advances in a manufacturing process. Therefore, according to the capacitance sensor, it is possible to achieve the reduction in size and cost compared to a capacitance sensor using an LC oscillation circuit.

According to another aspect of the disclosure, there is provided a capacitance sensor including an oscillation circuit; a switch circuit; a first reference capacitor; and a first electrode and a second electrode, the oscillation circuit includes an amplifier and a resonator connected between an input node and an output node of the amplifier, the first electrode is an electrode for sensing, the second electrode is an electrode having a fixed potential, the switch circuit switches between connecting the first electrode to and connecting one end of the first reference capacitor to a first node which is one of the input node and the output node of the amplifier, a first capacitance between the first electrode and the second electrode changes according to a state of a detection target, and an oscillation frequency of the oscillation circuit changes according to the first capacitance when the first electrode is connected to the first node.

In the capacitance sensor, when the first electrode is connected to the first node, the oscillation circuit oscillates based on the resonance by the resonator and the first capacitance rather than CR oscillation based on charging and discharging of the first capacitance between the first electrode and the second electrode, thereby being less likely to be affected by external amplitude noise. Therefore, according to the capacitance sensor, it is possible to detect the capacitance corresponding to the state of the detection target with high accuracy.

Further, according to the capacitance sensor, for example, the external device corrects the oscillation frequency in the period in which the first electrode is connected to the first node based on the oscillation frequency in the period in which one end of the reference capacitor is connected to the first node, thereby obtaining a highly accurate oscillation frequency in which the influence of the temperature or aging of the oscillation circuit is reduced, and it is thus possible to calculate the capacitance with high accuracy based on the oscillation frequency.

In addition, according to the capacitance sensor, since it is possible to achieve the reduction in size and cost compared to a capacitance sensor using an LC oscillation circuit, for example, it can be easily used even when the detection target is a small object.

The capacitance sensor according to the aspect of the disclosure may further include a measurement circuit configured to measure a first oscillation frequency of the oscillation circuit when the first electrode is connected to the first node and a second oscillation frequency of the oscillation circuit when the end of the first reference capacitor is connected to the first node of the amplifier.

According to the capacitance sensor, for example, the external device corrects the first oscillation frequency based on the second oscillation frequency, thereby obtaining a highly accurate oscillation frequency in which the influence of the temperature or aging of the oscillation circuit is reduced, and it is thus possible to calculate the capacitance with high accuracy based on the oscillation frequency.

The capacitance sensor according to the aspect of the disclosure may further include a clock generation circuit configured to generate a clock signal, and the measurement circuit may include a frequency divider circuit configured to divide a frequency of a signal based on oscillation of the oscillation circuit, and a counter configured to count the number of pulses of the clock signal included in a period in which a signal output from the frequency divider circuit is at a predetermined logic level.

The capacitance sensor according to the aspect of the disclosure may further include a buffer circuit to which a signal output from the resonator to the input node of the amplifier is input, and the frequency divider circuit may divide a frequency of a signal output from the buffer circuit.

In the capacitance sensor, since the resonator has a very high Q factor and therefore also functions as a noise filter, and the signal output from the resonator to the input node of the amplifier is a signal with little noise and close to a sine wave. Therefore, according to the capacitance sensor, since a spike due to noise does not occur in the output signal of the buffer circuit, the risk that the measurement circuit performs erroneous measurement is reduced.

In the capacitance sensor according to the aspect of the disclosure, the measurement circuit may calculate a ratio between the first oscillation frequency and the second oscillation frequency.

According to the capacitance sensor, the ratio between the first oscillation frequency and the second oscillation frequency is calculated, thereby obtaining a highly accurate oscillation frequency in which the influence of the temperature or aging of the oscillation circuit is reduced, and thus the external device can calculate the capacitance with high accuracy based on the oscillation frequency, for example.

In the capacitance sensor according to the aspect of the disclosure, the measurement circuit may measure each of the first oscillation frequency and the second oscillation frequency a plurality of times and calculate a ratio between an average value of the first oscillation frequency and an average value of the second oscillation frequency.

According to the capacitance sensor, the ratio between the average value of the first oscillation frequency measured a plurality of times and the average value of the second oscillation frequency measured a plurality of times is calculated, thereby obtaining a highly accurate oscillation frequency in which not only the influence of the temperature and aging of the oscillation circuit but also the influence of noise and instantaneous temperature change are reduced, and thus the external device can calculate the capacitance with higher accuracy based on the oscillation frequency, for example.

In the capacitance sensor according to the aspect of the disclosure, the measurement circuit may measure the second oscillation frequency once, then measure the first oscillation frequency twice, then measure the second oscillation frequency once, and calculate the ratio between the average value of the first oscillation frequency and the average value of the second oscillation frequency.

In this capacitance sensor, when the temperature changes during the measurement, the measurement error tends to increase or decrease in the order of the first measurement of the second oscillation frequency, the first measurement of the first oscillation frequency, the second measurement of the first oscillation frequency, and the second measurement of the second oscillation frequency. Therefore, according to the capacitance sensor, since the difference between the error included in the average value of the first oscillation frequency and the error included in the average value of the second oscillation frequency is reduced, the measurement accuracy is improved.

In the capacitance sensor according to the aspect of the disclosure, the measurement circuit may provide a waiting time between a measurement of the first oscillation frequency or the second oscillation frequency and a subsequent measurement of the first oscillation frequency or the second oscillation frequency.

According to the capacitance sensor, in the waiting time after the measurement is switched, even when the oscillation of the oscillation circuit becomes unstable or the oscillation stops, the measurement is not adversely affected.

The capacitance sensor according to the aspect of the disclosure may further include a substrate including a first surface and a second surface opposite to the first surface, the first electrode and the second electrode may be provided on the first surface of the substrate, and a ground electrode may be provided on the second surface of the substrate at a position opposite to an arrangement region of the first electrode and the second electrode on the first surface.

In the capacitance sensor, since the ground electrode is provided on the second surface of the substrate at the position opposite to the arrangement region of the first electrode and the second electrode on the first surface, when an object not being a detection target is located to face the second surface, the influence of the object on the first capacitance is reduced. Therefore, according to the capacitance sensor, it is possible to improve the detection accuracy of the capacitance.

In the capacitance sensor according to the aspect of the disclosure, the first node may be the output node of the amplifier.

In the capacitance sensor, since the resonator has a very high Q factor and therefore also functions as a noise filter, noise received from the first electrode connected to the output node of the amplifier is greatly reduced by the resonator, and the signal output from the resonator to the input node of the amplifier is a signal with little noise and close to a sine wave. Therefore, according to the capacitance sensor, the risk that the detection accuracy is reduced due to the noise received from the first electrode is reduced.

The capacitance sensor according to the aspect of the disclosure may further include a second reference capacitor provided inside the package; and a third electrode provided outside the package, the third electrode may be an electrode for sensing, the switch circuit may switch between a state in which the first electrode is connected to the first node and the third electrode is connected to a second node, which is the other of the input node and the output node of the amplifier, and a state in which the end of the first reference capacitor is connected to the first node and one end of the second reference capacitor is connected to the second node, and an oscillation frequency of the oscillation circuit may change according to the first capacitance and a second capacitance between the third electrode and the second electrode when the first electrode is connected to the first node and the third electrode is connected to the second node.

In the capacitance sensor, when the first electrode is connected to the first node and the third electrode is connected to the second node, since the oscillation frequency of the oscillation circuit changes according to the first capacitance and the second capacitance, it is possible to widen the variable width of the oscillation frequency compared to a case where the second capacitance is not provided. Therefore, according to the capacitance sensor, it is possible to improve the detection sensitivity of the capacitance.

The capacitance sensor according to the aspect of the disclosure may further include a substrate including a first surface and a second surface opposite to the first surface, the first electrode, the second electrode, and the third electrode may be provided on the first surface of the substrate, the second electrode may be located between the first electrode and the third electrode, and a ground electrode may be provided on the second surface of the substrate at a position opposite to an arrangement region of the first electrode, the second electrode, and the third electrode on the first surface.

In the capacitance sensor, since the ground electrode is provided on the second surface of the substrate at the position opposite to the arrangement region of the first electrode, the second electrode, and the third electrode on the first surface, when an object not being a detection target is located to face the second surface, the influence of the object on the first capacitance and the second capacitance is reduced. Therefore, according to the capacitance sensor, it is possible to improve the detection accuracy of the capacitance.

What is claimed is:

1. A capacitance sensor comprising:
a package;
an oscillation circuit provided inside the package;
a switch circuit provided inside the package;
a first reference capacitor provided inside the package; and
a first electrode and a second electrode provided outside the package, wherein
the oscillation circuit includes
an amplifier, and
a resonator provided inside the package and connected between an input node and an output node of the amplifier,
the first electrode is an electrode for sensing,
the second electrode is an electrode having a fixed potential,
the switch circuit switches between connecting the first electrode to and connecting one end of the first reference capacitor to a first node which is one of the input node and the output node of the amplifier, and
an oscillation frequency of the oscillation circuit changes according to a first capacitance between the first electrode and the second electrode when the first electrode is connected to the first node.

2. A capacitance sensor comprising:
an oscillation circuit;
a switch circuit;
a first reference capacitor; and
a first electrode and a second electrode, wherein
the oscillation circuit includes
an amplifier, and
a resonator connected between an input node and an output node of the amplifier,
the first electrode is an electrode for sensing,
the second electrode is an electrode having a fixed potential,
the switch circuit switches between connecting the first electrode to and connecting one end of the first reference capacitor to a first node which is one of the input node and the output node of the amplifier,
a first capacitance between the first electrode and the second electrode changes according to a state of a detection target, and
an oscillation frequency of the oscillation circuit changes according to the first capacitance when the first electrode is connected to the first node.

3. The capacitance sensor according to claim 1, further comprising:
a measurement circuit configured to measure a first oscillation frequency of the oscillation circuit when the first electrode is connected to the first node and a second oscillation frequency of the oscillation circuit when the end of the first reference capacitor is connected to the first node of the amplifier.

4. The capacitance sensor according to claim 3, further comprising:
a clock generation circuit configured to generate a clock signal, wherein
the measurement circuit includes
a frequency divider circuit configured to divide a frequency of a signal based on oscillation of the oscillation circuit, and
a counter configured to count the number of pulses of the clock signal included in a period in which a signal output from the frequency divider circuit is at a predetermined logic level.

5. The capacitance sensor according to claim 4, further comprising:
a buffer circuit to which a signal output from the resonator to the input node of the amplifier is input, wherein
the frequency divider circuit divides a frequency of a signal output from the buffer circuit.

6. The capacitance sensor according to claim 3, wherein
the measurement circuit calculates a ratio between the first oscillation frequency and the second oscillation frequency.

7. The capacitance sensor according to claim 3, wherein
the measurement circuit measures each of the first oscillation frequency and the second oscillation frequency a plurality of times and calculates a ratio between an average value of the first oscillation frequency and an average value of the second oscillation frequency.

8. The capacitance sensor according to claim 7, wherein
the measurement circuit measures the second oscillation frequency once, then measures the first oscillation frequency twice, then measures the second oscillation frequency once, and calculates the ratio between the average value of the first oscillation frequency and the average value of the second oscillation frequency.

9. The capacitance sensor according to claim 8, wherein
the measurement circuit provides a waiting time between a measurement of the first oscillation frequency or the second oscillation frequency and a subsequent measurement of the first oscillation frequency or the second oscillation frequency.

10. The capacitance sensor according to claim 1, further comprising:
a substrate including a first surface and a second surface opposite to the first surface, wherein
the first electrode and the second electrode are provided on the first surface of the substrate, and
a ground electrode is provided on the second surface of the substrate at a position opposite to an arrangement region of the first electrode and the second electrode on the first surface.

11. The capacitance sensor according to claim 1, wherein
the first node is the output node of the amplifier.

12. The capacitance sensor according to claim 1, further comprising:
a second reference capacitor provided inside the package; and
a third electrode provided outside the package, wherein
the third electrode is an electrode for sensing,
the switch circuit switches between a state in which the first electrode is connected to the first node and the third electrode is connected to a second node, which is the other of the input node and the output node of the amplifier, and a state in which the end of the first reference capacitor is connected to the first node and one end of the second reference capacitor is connected to the second node, and
an oscillation frequency of the oscillation circuit changes according to the first capacitance and a second capacitance between the third electrode and the second electrode when the first electrode is connected to the first node and the third electrode is connected to the second node.

13. The capacitance sensor according to claim 12, further comprising:
a substrate including a first surface and a second surface opposite to the first surface, wherein
the first electrode, the second electrode, and the third electrode are provided on the first surface of the substrate,
the second electrode is located between the first electrode and the third electrode, and
a ground electrode is provided on the second surface of the substrate at a position opposite to an arrangement region of the first electrode, the second electrode, and the third electrode on the first surface.
